(19) United States
(12) Patent Application Publication
(10) Pub. No.: US 2002/0163767 A1
(43) Pub. Date: Nov. 7, 2002

(54) Magnetoresistive sensor and a thin film magnetic head

(75) Inventor: Koichi Terunuma, Tokyo (JP)

Correspondence Address: OLIFF & BERRIDGE, PLC, P.O. BOX 19928, ALEXANDRIA, VA, 22320, US

(73) Assignee: TDK Corporation, Chuo-ku (JP)

(21) Appl. No.: 10/145,132

(22) Filed: May 15, 2002

Related U.S. Application Data
(62) Division of application No. 09/612,312, filed on Jul. 7, 2000.

(30) Foreign Application Priority Data
Aug. 26, 1999 (JP) 11-240,525
Jun. 5, 2000 (JP) 2000-167,691

(51) Int. Cl. G11B 5/39

(52) U.S. Cl. 360/324.12; 360/324.2

(57) ABSTRACT

A magnetic domain controlling film is provided on a soft magnetic film, and magnetizes the soft magnetic film in one direction. The magnetic domain controlling film has a large first thickness t1 enough to magnetize the soft magnetic film at both ends in the magnetization direction of the soft magnetic film, and has a small second thickness t2 enough for the magnetization of the soft magnetic film to be rotated at the central part in the magnetization direction of the soft magnetic film. The magnetic domain controlling film covers the soft magnetic film almost entirely.

### BACKGROUND OF THE INVENTION

1) Field of the Invention

This invention relates to a magnetoresistive sensor and a thin film magnetic head.

2) Related Art Statement

Recent magnetic disk driving device have a tendency to be miniaturized. In this tendency, thin film magnetic heads with magnetoresistive sensors using a magnetoresistive effect are well known as magnetic converters suitable for reading information stored in magnetic recording media in high recording density because they can read out regardless of relative velocities for magnetic recording media.

A reading element having an anisotropic magnetoresistive effective film (hereinafter, called as a “AMR film”) made of permalloy is generally used, but recently, a reading element having a giant magnetoresistive (hereinafter, called as a “GMR”) effective film, particularly a spin valve film structure is mainly used. A magnetoresistive sensor with the spin valve film structure is described in Kokai Publication Kokai Hei 4-35830 (JP A 4-35830) and “IEEE TRANSACTIONS ON MAGNETICS”, VOL. 30, No.6, NOVEMBER, 1994. The spin valve film structure has a soft magnetic film (free layer), a conductive non-magnetic film, a ferromagnetic film and antiferromagnetic film. The ferromagnetic film is stacked on the antiferromagnetic film to be bonded thereto with exchange interaction, and is magnetized (pinned) in one direction through the bonding with exchange interaction. In this specification, the pinned ferromagnetic film is often called as a “pinned layer”. The non-magnetic film is provided between the soft magnetic film and the ferromagnetic film.

When an external magnetic field is applied to the spin valve film structure, the magnetization direction of the soft magnetic film is rotated depending on the strength of the external magnetic field. The resistance of the spin valve film structure is determined by the angle of the magnetization direction of the soft magnetic film for the ferromagnetic film. When the magnetization direction of the soft magnetic film is opposite to the one of the ferromagnetic film, the resistance of the spin valve film structure becomes maximum, and when the magnetization direction of the soft magnetic film is the same as the one of the ferromagnetic film, the resistance becomes minimum.

Normally, for reducing the Barkliausen effect of the soft magnetic film, a magnetic domain controlling film to apply a longitudinal bias for the soft magnetic film is provided. The longitudinal bias is applied by the following methods: One is a method using a hard magnetic film (magnet layer) and the other is a method using an antiferromagnetic film. A longitudinal bias applying structure is disclosed in Kokai Publication Kokai Hei 10-112562 (JPA 10-112562), for example. In this document, longitudinal bias applying structures with the hard magnetic film and the antiferromagnetic film are disclosed, respectively. In the disclosed longitudinal bias applying structure with the antiferromagnetic film, two antiferromagnetic films are independently provided on both ends in the magnetization direction of the soft magnetic film by a given distance. The part of the surface of the soft magnetic film is exposed in between the two antiferromagnetic films, and thereby, a reading track width (RTW) of the reading element in which the magnetization of the soft magnetic film is rotated by an external applying magnetic field is determined.

As mentioned above, in conventional technique as typically disclosed in Kokai Publication Kokai Hei 10-112562, since the two antiferromagnetic films are provided on the soft magnetic film by a given distance and the part of the soft magnetic film is exposed in between the two antiferromagnetic films, the surface of the soft magnetic film may be damaged during a manufacturing step.

For example, the two antiferromagnetic films are formed by removing the central part of a uniform antiferromagnetic film formed on the soft magnetic film. This manufacturing step can be employed practically.

In the above conventional technique, when the central part of the uniform antiferromagnetic film is removed by milling to expose the part of the surface of the soft magnetic film and form the two independent antiferromagnetic film, the exposed part of the surface of the soft magnetic film may be damaged by the milling.

In the case of using two independent hard magnetic films instead of the two independent antiferromagnetic films, the above problem occurs.

Recently, attention is paid to a tunnel magnetoresistive effective element (hereinafter, called as a “TMR element”) as another type of the GMR effective film. The TMR element has a ferromagnetic tunnel effective film composed of a multi-layered structure of ferromagnetic layer/non-magnetic layer/ferromagnetic layer. The ferromagnetic tunnel effect means the phenomenon that when a current is flown in between a pair of ferromagnetic layers via a non magnetic layer, a tunnel current through the non-magnetic layer varies on the relative angle in the magnetization between both of the ferromagnetic layers. The non-magnetic layer is composed of a so thin insulating film that electrons can pass through the layer with maintaining their spin conditions. In the TMR element, a magnetic domain controlling film is also required to prevent Barklausen effect in one ferromagnetic layer, so that the above-mentioned problem in the spin valve film structure occurs in this case.

### SUMMARY OF THE INVENTION

It is an object of the present invention to provide a magnetoresistive sensor and a thin film magnetic head with the sensor in which a soft magnetic film adjacent to magnetic domain controlling films is not damaged in between the controlling films.

It is another object of the present invention to provide manufacturing methods suitable for the magnetoresistive sensor and the thin film magnetic head.

For achieving the objects, a magnetoresistive sensor of the present invention includes a soft magnetic film and a magnetic domain controlling film. The magnetic domain controlling film is provided entirely on the soft magnetic film, and has a first thickness at both ends in a magnetization direction of the soft magnetic film and has a second thickness smaller than the first thickness at the central part in the magnetization direction thereof when the soft magnetic film is magnetized in one direction.

In the case that the magnetoresistive sensor of the present invention is composed of a spin valve film structure including the above soft magnetic film and magnetic domain controlling film, the soft magnetic film corresponds to a free layer, and a conductive non-magnetic layer and a ferromagnetic layer are provided on the opposite surface of the soft magnetic film to the surface thereof on which the magnetic domain controlling film is formed. The ferromagnetic layer corresponds to a pinned layer.

When an external magnetic field is applied to the spin valve film structure, the magnetization of the soft magnetic film is rotated depending on the strength of the external magnetic field. The resistance of the non-magnetic film becomes maximum when the magnetization direction of the soft magnetic film is opposite to that of the ferromagnetic film, and it becomes minimum when the magnetization direction of the soft magnetic film is the same as that of the ferromagnetic film. The external magnetic field can be detected from the change in the sense current due to the resistance change.

The magnetic domain controlling film is provided entirely on the soft magnetic film, and has the first thickness at both ends in the magnetization direction of the soft magnetic film. The first thickness is large enough to magnetize the soft magnetic film. As a result, a longitudinal bias is applied to the soft magnetic film, and thereby, the Barkhausen noise due to magnetic domain wall shift can be prevented in the soft magnetic film.

The magnetic domain controlling film has the second thickness smaller than the first thickness at the central part in the magnetization direction of the soft magnetic film. The second thickness is small enough for the magnetization of the soft magnetic film to be rotated. The central part defines a reading track (RTW) of the magnetoresistive sensor in which the magnetization of the soft magnetic film is rotated by an external applying magnetic field.

Moreover, the soft magnetic film is entirely covered with the magnetic domain controlling film. Therefore, it is not required to remove the central part of the magnetic domain controlling film by milling or the like and expose a part of the surface of the soft magnetic film for forming two independent magnetic domain controlling films, so that the surface of the soft magnetic film is not damaged. As a result, in the magnetoresistive sensor having the spin valve film structure with substantially two magnetic domain controlling films according to the present invention, the soft magnetic film is not damaged in between the magnetic domain controlling films.

The magnetic domain controlling film may be composed of an antiferromagnetic film or a hard magnetic film. In the case of composing the magnetic domain controlling film of the antiferromagnetic film, the antiferromagnetic film has the larger first thickness enough to be bonded to the soft magnetic film with exchange interaction at both ends of the soft magnetic film, and has the smaller second thickness substantially not to be bonded to the soft magnetic film with exchange interaction at the central part of the soft magnetic film. In the case of composing the magnetic domain controlling film of the hard magnetic film, the hard magnetic film has the larger first thickness enough to apply a longitudinal bias magnetic field for the soft magnetic film at both ends of the soft magnetic films, and has the smaller second thickness enough not to have its magnetism at the central part of the soft magnetic film.

In another embodiment according to the present invention, two independent magnetic domain controlling films are provided at both ends in a magnetization direction of the soft magnetic film via a protection film. The protection film is required to be thinner than the magnetic domain controlling films.

Hereinafter, in the case of composing the magnetic domain controlling film of the antiferromagnetic film, the material and the second thickness of the antiferromagnetic film will be described. Moreover, thin invention relates to a thin film magnetic head having the above magnetoresistive sensor and a manufacturing method of the magnetoresistive sensor.

In the case that the magnetoresistive sensor of the present invention is composed of a TMR element including the above soft magnetic film and magnetic domain controlling film, the magetoresistive sensor has a similar film structure to the one with the spin valve film structure, except that a non-magnetic film between a ferromagnetic film and the soft magnetic film functions as a tunnel barrier layer and the sensor has a power supply structure to flow a sense current in a different direction by 90 degrees.

The other objects, configurations and advantages will be explained in detail, with reference to the attaching drawings in embodiments.

### BRIEF DESCRIPTION OF THE DRAWINGS

For a better understanding of this invention, reference is made to the attached drawings, wherein:

FIG. 1 is a view showing an example in the magnetoresistive sensor of the present invention,

FIG. 2 is a graph showing the relation between the second thickness of a IrMn antiferromagnetic film constituting the magnetic domain controlling film and a bonding magnetic field with exchange interaction,

FIG. 3 is a view showing another example in the magnetoresistive sensor of the present invention,

FIG. 4 is a view showing still another example in the magnetoresistive sensor of the present invention,

FIG. 5 is a view showing further example in the magnetoresistive sensor of the present invention,

FIG. 6 is a perspective view showing a thin film magnetic head with a magnetoresistive sensor according to the present invention,

FIG. 7 is an enlarged cross sectional view of the thin film magnetic head shown in FIG. 6,

FIG. 8 is an enlarged perspective view of the reading element of the thin film magnetic head shown in FIGS. 6 and 7,

FIG. 9 is a structural view of the reading element of the thin film magnetic head shown in FIGS. 6 and 7,

FIG. 10 is a view showing one step in a manufacturing method of a magnetoresistive sensor according to the present invention,

FIG. 11 is a view showing the step after the step shown in FIG. 10,

FIG. 12 is a view showing the step after the step shown in FIG. 11,

FIG. 13 is a view showing the step after the step shown in FIG. 12,

FIG. 14 is a view showing the step after the step shown in FIG. 13,

FIG. 15 is a view showing one step in another manufacturing method of a magnetoresistive sensor,

FIG. 16 is a view showing the step after the step shown in FIG. 15, and

FIG. 17 is a view showing the step after the step shown in FIG. 16.

### DETAILED DESCRIPTION OF THE PREFERRED EMBODIMENTS

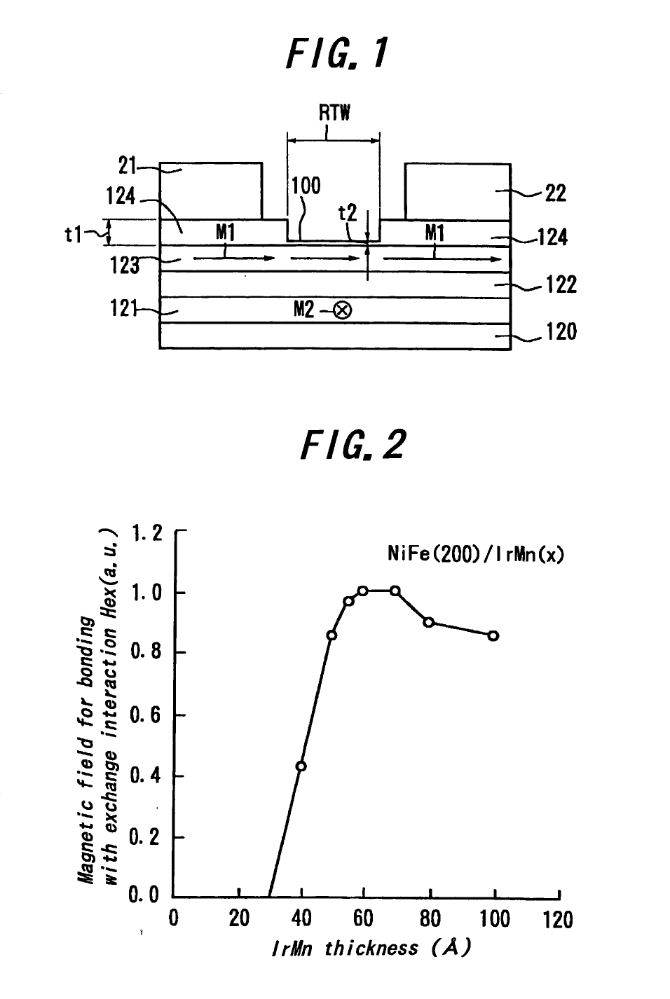

FIG. 1 is a view showing a magnetoresistive sensor according to the present invention. The illustrated magnetoresistive sensor has a spin valve film structure. The spin valve film structure includes an antiferromagnetic film 120, a ferromagnetic film 121, a non-magnetic film 122, a soft magnetic film 123 and a magnetic domain controlling film 124.

The antiferromagnetic film 120 may be made of a well known material. A Mn-incorporated alloy, a Mn-incorporated compound, an oxide and PtCr are exemplified. As the Mn-incorporated alloy, PtMn, IrMn, FeMn, RhMn, NiMn, RuMn, RuRhMn or PtPdMn is exemplified. As the oxide, NiO, CoO or Fe₂O₃ is exemplified. The antiferromagnetic film 120 has a thickness of 5-25 nm, for example. The ferromagnetic film 121 is stacked on the antiferromagnetic film 120, and is bonded to the film 120 with exchange interaction to be magnetized in the M2 arrow direction. The magnetization direction is pinned. That is, the antiferromagnetic film 120 functions as a pinning layer, and thus, the ferromagnetic film 121 functions as a pinned layer. The non-magnetic film 122 is formed adjacent to the ferromagnetic film 121. The non-magnetic film 122 is made of a Cu material in a thickness of about 3 nm, for example.

The soft magnetic film 123 is formed adjacent to the non-magnetic film 122, and functions as a free layer. The soft magnetic film 123 is made of NiFe in a thickness of about 10 nm, for example. In this example, the soft magnetic film 123 is composed of a single layer, but it may be composed of a multi-layered structure such as NiFe film/Co film structure.

The magnetic domain controlling film 124 is formed adjacent to the soft magnetic film in the opposite side to the non-magnetic film 122, and magnetizes the soft magnetic film 123 in the M1 arrow direction. The magnetic domain controlling film 124 has a larger first thickness t1 enough to magnetize the soft magnetic film 123 at both ends in the magnetization direction M1 of the soft magnetic film 123, and has a smaller second thickness t2 enough for the magnetization of the soft magnetic film 123 to be rotated at the central part 100 in the magnetization direction M1 of the film 123. The soft magnetic film 123 is covered almost entirely with the magnetic domain controlling film 124 with the first and second thickness.

Leading electrodes 21 and 22 to supply a sense current are provided on the magnetic domain controlling film 124. The leading electrodes 21 and 22 may be provided on the side surface of the spin valve film structure shown in FIG. 1.

When an external magnetic field is applied, the magnetization of the soft magnetic film 123 is rotated from the direction M1 depending on the strength of the external magnetic field. The resistance of the spin valve film structure mainly depends on the resistance of the non-magnetic film 122 between the soft magnetic film 123 and the ferromagnetic film 121. The resistance of the non-magnetic film 122 becomes maximum when the magnetization direction of the soft magnetic film 123 is opposite to the magnetization direction M2 of the ferromagnetic film 121, and it becomes minimum when the magnetization direction is the same as the magnetization direction M2. Therefore, the resistance of the spin valve film structure constituting the magnetoresistive sensor of the present invention is determined by the angle of the magnetization direction of the soft magnetic film 123 for the magnetization direction M2 of the ferromagnetic film 121. The external magnetic field can be detected from the change in the sense current due to the above resistance change.

Since the magnetic domain controlling film 124 is formed adjacent to the soft magnetic film 123, and has the larger first thickness t1 at both ends in the magnetization direction M1 of the soft magnetic film 123, it can apply a longitudinal bias to the film 123. Therefore, in the soft magnetic film 123, the Barkhausen noise due to magnetic domain wall shift can be prevented.

The magnetic domain controlling film 124 has the smaller second thickness enough for the magnetization of the soft magnetic film 123 to be rotated at the central part 100 in the magnetization direction M1 of the film 123. The width of the central part determines a reading track width (RTW) of the magnetoresistive sensor in which the magnetization of the soft magnetic film is rotated by the external magnetic field.

Moreover, the soft magnetic film 123 is covered almost entirely with the magnetic domain controlling film 124, and particularly, even the central part of the film 123 is covered with the central part 100 of the film 124 with the second thickness t2. In this case, it is not required to remove the central part of the magnetic domain controlling film 124 by milling or the like and expose the part of the surface of the soft magnetic film 123 to form two dependent magnetic domain controlling films. Therefore, the surface of the soft magnetic film 123 is not damaged by the milling or the like. As a result, in the magnetoresistive sensor having the spin valve film structure substantially two independent magnetic domain controlling films, the soft magnetic film is not damaged.

The magnetic domain controlling film 124 may be composed of a hard magnetic film (magnet film) or an antiferromagnetic film. The hard magnetic film is made of CoPt, CoPtCr, SmCo, NbFeB or the like. The antiferromagnetic film is made of the same material as that of the above antiferromagnetic film 120. Concretely, it may be made of at least one selected from the group consisting of PtMn, IrMn, FeMn, RhMn, NiMn, RuMn, RuRhMn, PtPdMn, NiO or PtCr.

In the case of composing the magnetic domain controlling film 124 of the antiferromagnetic film, the film 124 has the first thickness t1 enough to be bonded to the soft magnetic film 123 with exchange interaction at both ends of the film 123 and has the second thickness t2 enough not to substantially generate a magnetic field for the bonding with exchange interaction.

The second thickness t2 of the magnetic domain controlling film 124 depends on the materials of the films 123 and 124. The second thickness t2 suitable for the materials is determined experimentally as follows.

Table 1 shows the experimental data of the limitation thickness (maximum thickness) of the magnetic domain controlling film composed of a IrMn film, a FeMn film, a NiMn film, a NiO film, a PtMn film, a PtCrMn film, a PtPdMn film RuMn film, a RuRhMn film or a RhMn film in which a magnetic field Hex for bonding with exchange interaction is not generated, provided that the soft magnetic film 123 is composed of a NiFe film with a thickness of 20 nm. If the magnetic domain controlling film is thinner than the limitation thickness listed in Table 1, the magnetic field for bonding with exchange interaction Hex is not generated. Therefore, the part of the magnetic domain controlling film with the second thickness t2 smaller than the limitation thickness at the central part 100 turns out to vanish magnetically. As a result, the width of the central part 100 defines the reading track width (RTW) in which the magnetization of the soft magnetic film is rotated by the external magnetic field.

TABLE 1

| Antiferromagnetic material | Limitation thickness (nm) |
|---|---|
| IrMn | 3 |
| FeMn | 3 |
| NiMn | 15 |
| PtMn | 10 |
| PtCrMn | 10 |
| NiO | 15 |
| PtPdMn | 10 |
| RuMn | 5 |
| RuRhMn | 5 |
| RhMn | 5 |

Referring to Table 1, the magnetic domain controlling film 124 composed of the IrMn film or the FeMn film does not exhibit the magnetic field Hex for bonding with exchange interaction in the second thickness t2 of less than 3 nm. That is, the part of the magnetic domain controlling film 124 with the thickness t2 turns out to vanish magnetically, and the width of the central part 100 defines the reading track width (RTW) in which the magnetization of the soft magnetic film is rotated by the external magnetic field.

FIG. 2 is a graph showing the relation between the second thickness t2 of the magnetic domain controlling film 124 composed of the IrMn film and the magnetic field for bonding with exchange interaction. In this case, when the second thickness t2 is smaller than 3 nm, the magnetic field for bonding with exchange interaction becomes almost zero.

The magnetic domain controlling film 124 composed of the NiMn film or the NiO film does not exhibit the magnetic field Hex for bonding with exchange interaction in the second thickness t2 of less than 15 nm. That is, the part of the magnetic domain controlling film 124 with the thickness t2 turns out to vanish magnetically, and the width of the central part 100 defines the reading track width (RTW) in which the magnetization of the soft magnetic film is rotated by the external magnetic field.

Moreover, the magnetic domain controlling film 124 composed of the PtMn film, the PtPdMn film or the PtCr film does not exhibit the magnetic field Hex for bonding with exchange interaction in the second thickness t2 of less than 10 nm. That is, the part of the magnetic domain controlling film 124 with the thickness t2 turns out to vanish magnetically, and the width of the central part 100 defines the reading track width (RTW) in which the magnetization of the soft magnetic film is rotated by the external magnetic field.

The magnetic domain controlling film 124 composed of the RuMn film, the RuRhMn film or the RhMn film does not exhibit the magnetic field Hex for bonding with exchange interaction in the second thickness t2 of less than 5 nm.

In the case of composing the magnetic domain controlling film 124 of the hard magnetic film, the film 124 has the first thickness t1 enough to apply a longitudinal bias magnetic field to the soft magnetic film 123, and has the second thickness t2 not to have its magnetism (to have a super paramagnetism). As mentioned above, the second thickness t2 can be determined experimentally on the material of the hard magnetic film.

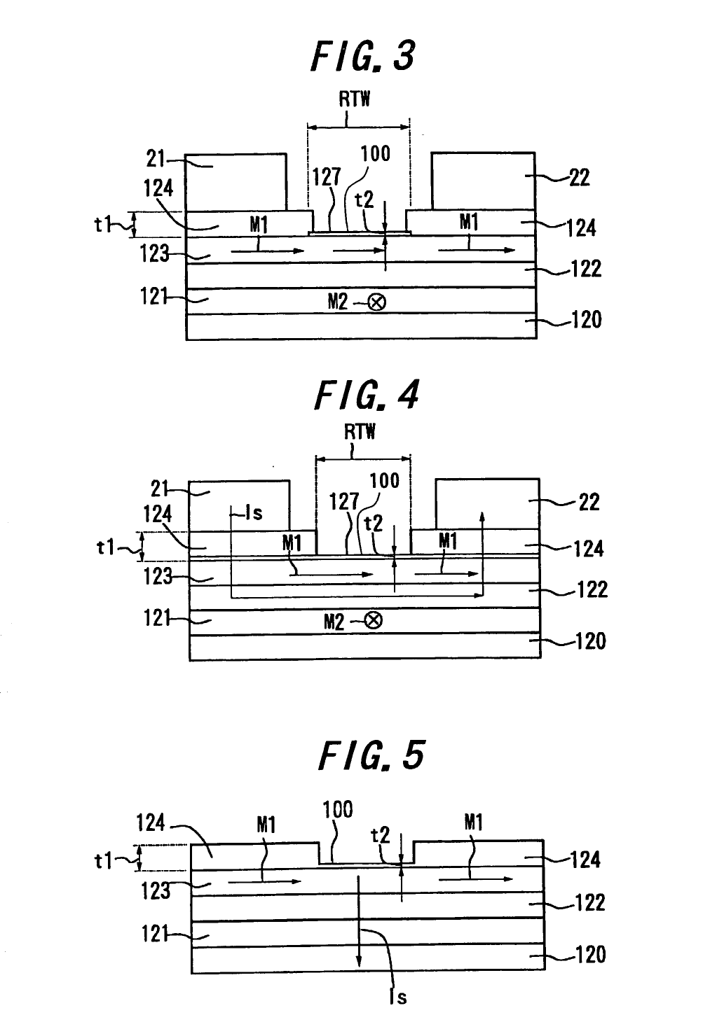

FIG. 3 is a view showing another magnetoresistive sensor according to the present invention. In FIG. 3, like characters are given to the similar parts to the ones in FIG. 1.

The illustrated magnetoresistive sensor has a protection film 127 made of NiFe or the like at the central part 100. Two magnetic domain controlling films 124 are provided with separation by a distance RTW on both ends in the magnetization direction M1 of the soft magnetic film 123 (on the opposite surface thereof to the one on which the non-magnetic film 122 is formed). The protection film 127 has the second thickness t2 smaller than the first thickness t1 of the magnetic domain controlling film 124, and covers the soft magnetic film 123 entirely, particularly in the part of the film 123 corresponding to the central part 100.

In this case, it is not required to remove the central part of the magnetic domain controlling film 124 by milling or the like and expose the part of the surface of the soft magnetic film 123 to form two dependent magnetic domain controlling films. Therefore, the surface of the soft magnetic film 123 is not damaged by the milling or the like. As a result, in the magnetoresistive sensor having the spin valve film structure with substantially two independent magnetic domain controlling films, the soft magnetic film is not damaged. As mentioned above, the magnetic domain controlling film 124 may be composed of a hard magnetic film or an antiferromagnetic film made of above-mentioned material.

FIG. 4 is a view showing still another magnetoresistive sensor according to the present invention. In FIG. 4, like characters are given to the similar parts to the ones in FIGS. 1 and 3. The illustrated magnetoresistive sensor has the protection film 127 almost entirely on the soft magnetic film 123. The protection film 127 has the second thickness t2 smaller than the first thickness t1 of the magnetic domain controlling film 124, and covers the soft magnetic film 123 entirely, particularly even the part of the film 123 corresponding to the central part 100. The two magnetic domain controlling films 124 are provided with separation by a distance RTW on both ends in the magnetization direction M1 of the soft magnetic film 123. The magnetic domain controlling films 124 are composed of the hard magnetic film (magnet film).

In this case, it is not required to remove the central part of the magnetic domain controlling film 124 by milling or the like and expose the part of the surface of the soft magnetic film 123 to form two dependent magnetic domain controlling films. Therefore, the surface of the soft magnetic film 123 is not damaged by the milling or the like. As a result, in the magnetoresistive sensor having the spin valve film structure with substantially two independent magnetic domain controlling films, the soft magnetic film is not damaged.

FIG. 5 is a view showing further magnetoresistive sensor according to the present invention. The illustrated magnetoresistive sensor is composed of a TMR element having the antiferromagnetic film 120, the ferromagnetic film 121, the non-magnetic film 122, the soft magnetic film 123 and the magnetic domain controlling film 124.

The ferromagnetic film 121 is bonded to the antiferromagnetic film 120 with exchange interaction, and magnetized in one direction. Therefore, the antiferromagnetic film 120 functions as a pinning layer for the ferromagnetic film 121, and the ferromagnetic film 121 functions as a pinned layer.

The non-magnetic film 122 is formed adjacent to the ferromagnetic film 121, and functions as a tunnel barrier layer. The soft magnetic film 123 is formed adjacent to the non-magnetic film 122, and functions as a free layer.

The magnetic domain controlling film 124 is provided on the soft magnetic film 123 (on the opposite surface thereof to the non-magnetic film 122), and magnetizes the film 123 in the M1 direction. The magnetic domain controlling film 124 has a similar configuration to the one in FIG. 1. That is, the film 124 has the first thickness t1 enough to magnetize the soft magnetic film 123 on both ends in the magnetization direction M1 of the film 123, and has the second thickness t2 enough for the magnetization of the film 123 to be rotated at the central part 100 in the magnetization direction M1 of the film 123. Therefore, the soft magnetic film 123 is covered with the magnetic domain controlling film 124, and particularly, the central part thereof is covered with the central part 100 of the film 124 with the second thickness t2.

The antiferromagnetic film 120 and the magnetic domain controlling film 124 are used as a current supplying path for a sense current Is. In this case, therefore, a leading electrode film is preferably provided for the films 120 and 124.

The soft magnetic film 123 and the ferromagnetic film 121 are preferably made of a highly polarized material such as Fe, Co, Ni, FeCo, NiFe, CoZrNb, FeCoNi or the like. The films may have two-layered structure. The non-magnetic film 123 preferably has a thickness of 1-10 nm, particularly, 2-5 nm. Too thick non-magnetic film may decrease the output in the magnetoresistive sensor. Too thin non-magnetic film may increase the noise at operation due to its unstable magnetic properties. The ferromagnetic film 121 preferably has a thickness of 1-10 nm, particularly 2-5 nm. Too thick ferromagnetic film 120 may weaken the pinning strength therein, and too thin ferromagnetic film 120 may decrease the TMR variation ratio.

The non-magnetic film 122 is made of Al₂O₃, NiO, GdO, MgO, Ta₂O₅, MoO, TiO₂, WO₂ or the like. It is desired that the non-magnetic film 122 is as thin as possible in view of the reduction of the resistance of the magnetoresistive sensor, but too thin film 122 may generate a leak current through pin holes therein. Therefore, the film 122 has preferably a thickness of 0.5-2 nm.

The antiferromagnetic film 120 and the magnetic domain controlling film 124 may be made of the same materials in the same thickness as in the above magnetoresistive sensor having the spin valve film structure.

In this case, the ferromagnetic film 121 is bonded to the antiferromagnetic film 120 with exchange interaction, and the magnetization of the film 121 is pinned through the bonding with exchange interaction. Therefore, the film 121 functions as a pinned layer. When an external magnetic field is applied, the magnetization of the soft magnetic film 123 is rotated depending on the strength of the magnetic field. The resistance of the TMR element constituting the magnetoresistive sensor of the present invention is determined by the angle of the magnetization direction of the soft magnetic film 123 for the magnetization direction M2 of the ferromagnetic film 121. The resistance of the non-magnetic film 122 becomes maximum when the magnetization direction of the soft magnetic film 123 is opposite to the magnetization direction M2 of the ferromagnetic film 121, and it becomes minimum when the magnetization direction is the same as the magnetization direction M2. The external magnetic field can be detected from the change in the sense current due to the above resistance change.

Since the magnetic domain controlling film 124 is provided on the soft magnetic film 123, and has the first thickness t1 enough to magnetize the film 123 on both ends in the magnetization direction M1 of the film 123, it can apply a longitudinal bias to the film 123. Therefore, in the film 123, the barkhausen noise due to magnetic domain wall shift can be prevented.

In this case, particularly, the central part of the soft magnetic film 123 is covered with the central part 100 of the magnetic domain controlling film 124 with the second thickness. It is not required to remove the central part of the magnetic domain controlling film 124 by milling or the like and expose the part of the surface of the soft magnetic film 123 to form two dependent magnetic domain controlling films. Therefore, the surface of the soft magnetic film 123 is not damaged by the milling or the like. As a result, in the magnetoresistive sensor having the spin valve film structure with substantially two independent magnetic domain controlling films, the soft magnetic film is not damaged. The magnetoresistive sensor with the TMR element can have a similar configuration to the one shown in FIG. 3 or 4.

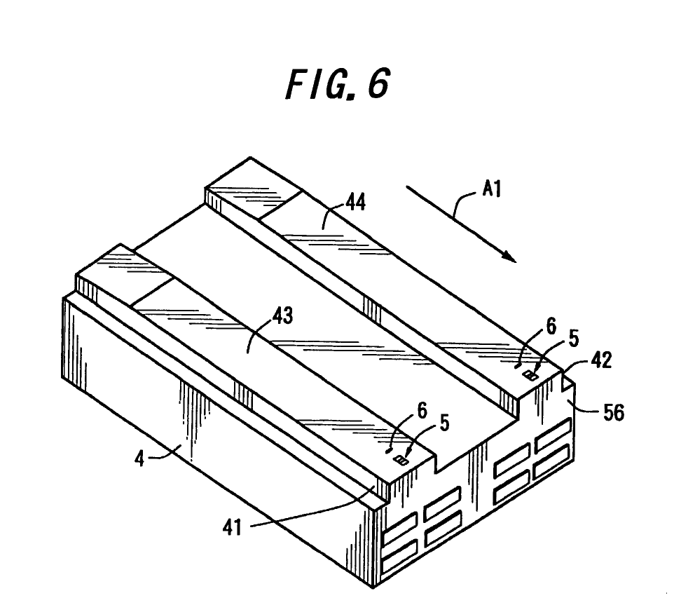

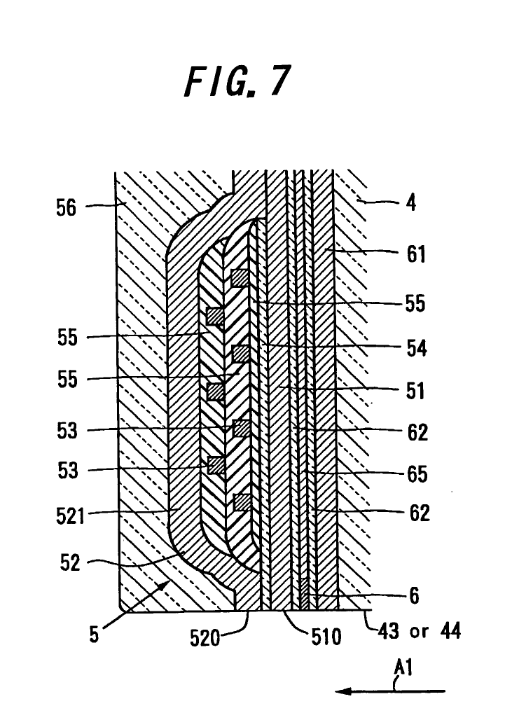

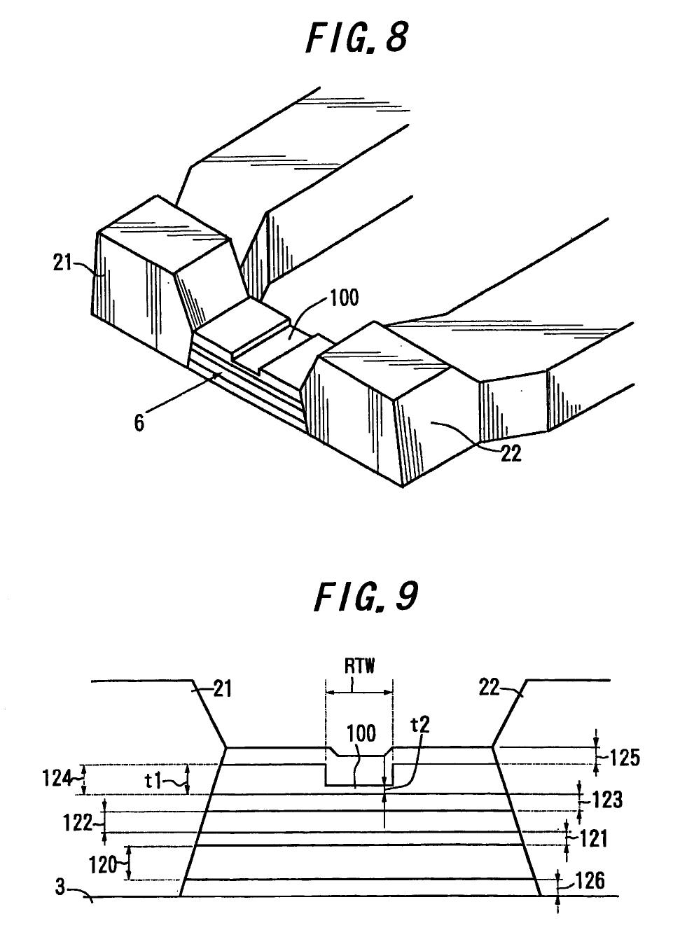

FIG. 6 is a perspective view of a thin film magnetic head having the above magnetoresistive sensors as reading elements and inductive type magnetoresistive sensors as writing elements, and FIG. 7 is an enlarged cross sectional view of the thin film magnetic head shown in FIG. 6. FIG. 8 is an enlarged perspective view of the reading element, and FIG. 9 is a structural view of the reading element shown in FIG. 8. The illustrated thin film magnetic head has, on a slider 4, reading elements 6 composed of the magnetoresistive sensor and writing elements 5 composed of inductive type magnetic conversion element. The arrow A1 designates a medium moving direction.

The slider 4 is composed of a ceramic structural body with a substrate made of Al₂O₃—TiC, etc., and an insulating film 62 made of Al₂O₃ or SiO₂, etc. The slider 4 has air bearing surfaces (hereinafter, called as “ABS”s) 43 and 44 on its medium opposing surface. Not shown in the figure, the ABSs 43 and 44 may have various geometrical shapes for improving the floating performance of the thin film magnetic head. Moreover, in this example, the slider 4 has rail parts 41 and 42 for generating a positive pressure, but may have ones for generating a negative pressure.

The reading element 6 is embedded in the insulating film 62, and is composed of a magnetoresistive sensor according to the present invention. Therefore, the thin film magnetic head in this example exhibits the same operation and effect as the MR type magnetoresistive sensor. A bottom shielding film 61 is composed of a magnetic film made of permalloy.

The reading element 6 shown in FIGS. 8 and 9 has the antiferromagnetic film 120 on an underfilm 126, and a non magnetic protection film 125 on the magnetic domain controlling film 124. The leading electrodes 21 and 22 are provided on the side surface of the spin valve film structure shown in FIG. 9.

The writing element 5 has a bottom magnetic film 51, a top magnetic film 52, a coil film 53, a gap film 54 made of alumina, an insulating film 55 and a protection film 56, and is stacked on the insulating film 62. The forefronts of the bottom and top magnetic films 51 and 52 are opposed via the gap film 54 with a minute thickness, and thereby, constitutes pole portions 510 and 520 for writing. The bottom magnetic film 51 and the yoke portion 521 of the top magnetic film 52 are joined at a back gap portion opposite to the pole portions 510 and 520 to complete a magnetic circuit. The coil film 53 is formed in the insulating film 55 so as to wind spirally around the back gap portion. Although in this example, a longitudinal magnetic recording/reproducing magnetic head is exemplified, this invention includes a perpendicular magnetic recording/reproducing magnetic head or the like.

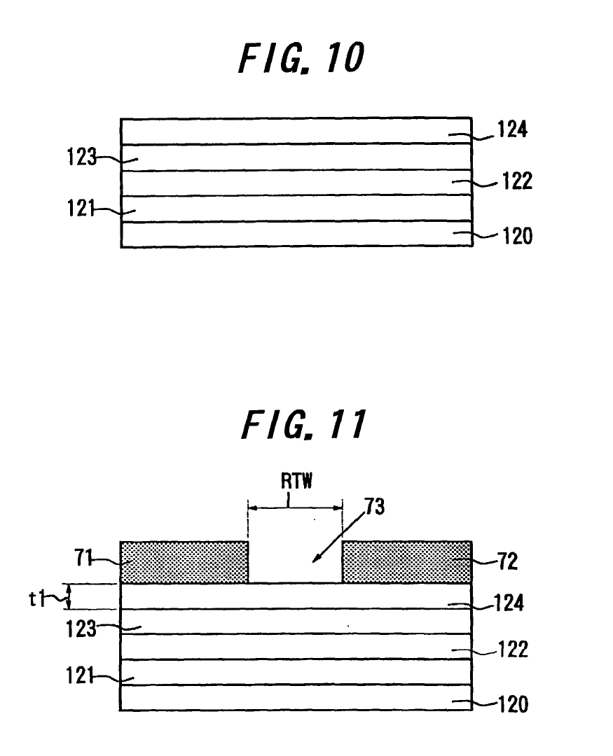

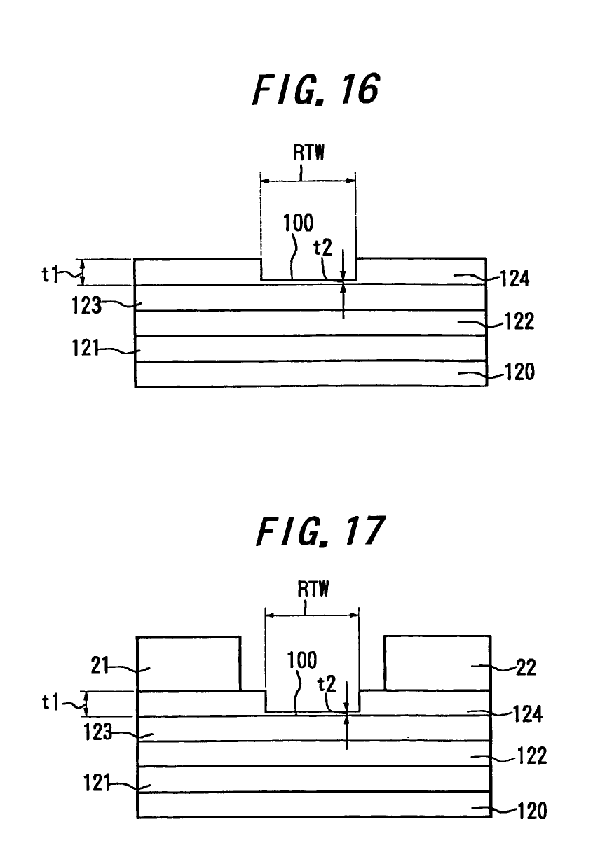

A manufacturing method of the above magnetoresistive sensor according to the present invention will be described with reference to FIGS. 10-17. The manufacturing method can be employed for the reading element 6 of the thin film magnetic head shown in FIGS. 6-9.

FIGS. 10-14 show a first example in the manufacturing method of the present invention. First of all, as shown in FIG. 10, the antiferromagnetic film 120, the ferromagnetic film 121, the non-magnetic film 122, the soft magnetic film 123 and the magnetic domain controlling film 124 are formed in turn. In this step, the magnetic domain controlling film 124 is formed entirely on the soft magnetic film 123. Moreover, in this step, leading electrodes may be formed on the magnetic domain controlling film 124.

Then, as shown in FIG. 11, masks 71 and 72 are formed on the magnetic domain controlling film 124 through patterning with photo-lithography. The reading track width (RTW) for magnetization rotation of the soft magnetic film is defined by the width of the opening 73 between the masks 71 and 72.

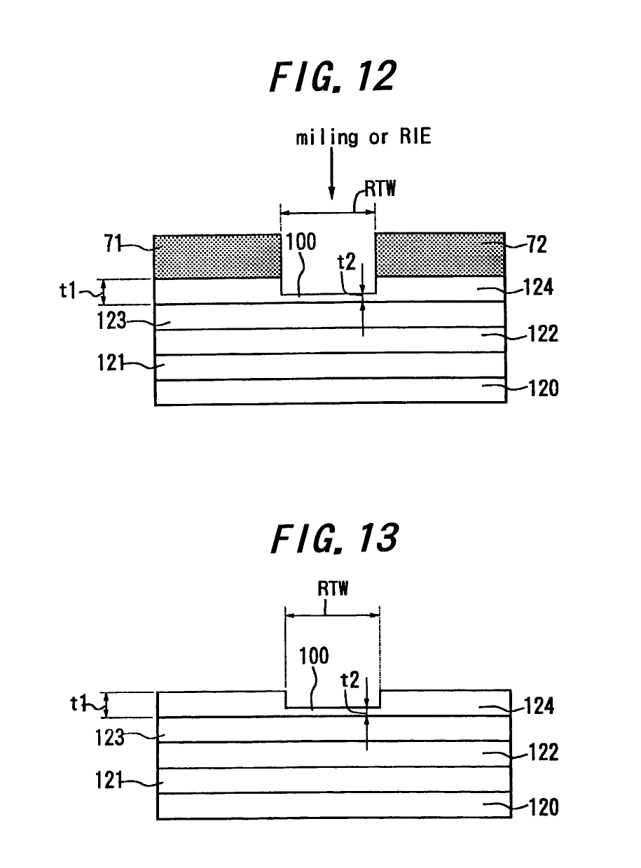

Subsequently, as shown in FIG. 12, the part of the magnetic domain controlling film 124 is removed by ion milling or reactive ion etching (RIE) through the opening 73 between the masks 71 and 72 so as to have the central part 100 with a thickness of t2. In this step, the soft magnetic film 123 is not damaged by the above ion milling or the RIE because the central part 100 be left on the film 123.

Thereafter, the masks 71 and 72 are removed, and the magnetoresistive sensor shown in FIG. 13 can be obtained. In this sensor, the magnetic domain controlling film 124 has the large first thickness t1 enough to magnetize the soft magnetic film 123 at both ends in the magnetization direction of the film 123, and has the small second thickness t2 enough for the soft magnetic film 123 to be rotated at the central part 100 in the magnetization direction of the film 123.

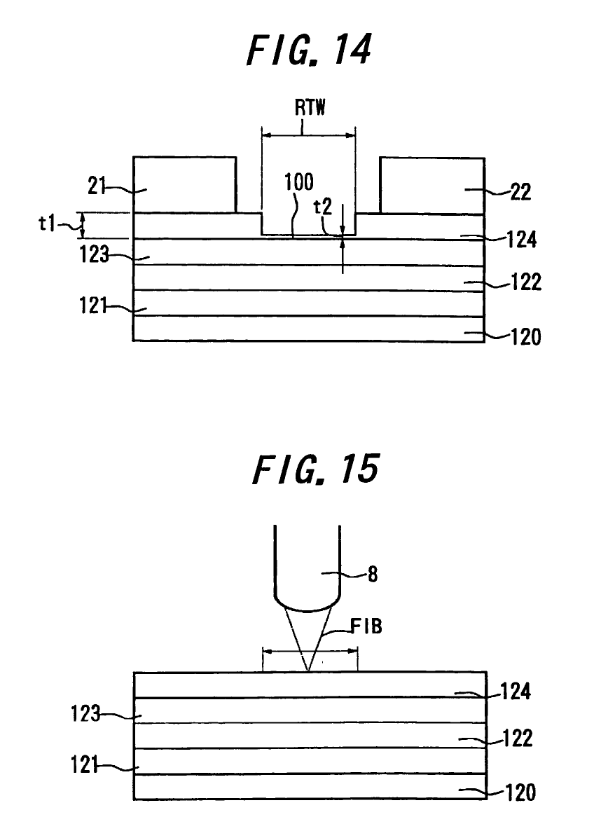

In the magnetoresistive sensor shown in FIG. 14, the leading electrodes 21 and 22 are formed on the parts of the magnetic domain controlling film 124 with the first thickness t1. In the case of forming the leading electrodes in the step shown in FIG. 10, the step shown in FIG. 14 may be omitted.

FIGS. 15-17 shows a second example in the manufacturing method of the present invention. First of all, as shown in FIG. 15, the antiferromagnetic film 120, the ferromagnetic film 121, the non-magnetic film 122, the soft magnetic film 123 and the magnetic domain controlling film 124 are formed in turn. In this step, the magnetic domain controlling film 124 is formed entirely on the soft magnetic film 123. Moreover, in this step, the leading electrodes may be formed.

Then, as shown in FIG. 15, the central part of the magnetic domain controlling film 124 is removed by focus ion beam (FIB) from a focus ion beam apparatus 8. Therefore, the magnetic domain controlling film 124 has the large first thickness t1 enough to magnetize the soft magnetic film 123 at both ends in the magnetization direction of the film 123, and the small second thickness t2 enough for the soft magnetic film 123 to be rotated at the central part in the magnetization direction of the film 123, and thus, the magnetoresistive sensor having the magnetic domain controlling film 124 can be obtained.

The soft magnetic film 123 is not damaged by the FIB because the central part of the magnetic domain controlling film 124 with the thickness t2 is left on the film 124.

In the magnetoresistive sensor shown in FIG. 17, the leading electrodes 21 and 22 are formed on the parts of the magnetic domain controlling film 124 with the first thickness t1. In the case of forming the leading electrodes in the step shown in FIG. 15, the step shown in FIG. 17 may be omitted.

Not depicted, the manufacturing method shown in FIGS. 10-17 can be applied for the magnetoresistive sensors and the thin film magnetic head shown in FIGS. 3-5 with a little different steps.

As mentioned above, in the manufacturing method shown in FIG. 10-17, the magnetic domain controlling film 124 may be composed of a hard magnetic film or an antiferromagnetic film. In the case of composing the film 124 of the antiferromagnetic film, the film 124 has the first thickness t1 enough to be bonded to the soft magnetic film 123 with exchange interaction at both ends in the film 123, and has the second thickness t2 enough not to substantially have a magnetic field for bonding with exchange interaction. Then, the second thickness t2 depends on the compositions and materials of the soft magnetic film 123 and the magnetic domain controlling film 124.

As mentioned above, this invention can provide the following effects:

(a) a magnetoresistive sensor and a thin film magnetic head with the sensor in which a soft magnetic film adjacent to magnetic domain controlling films is not damaged in between the controlling films can be provided.

(b) manufacturing methods suitable for the magnetoresistive sensor and the thin film magnetic head can be provided.

What is claimed is:

1. A magnetoresistive sensor comprising a soft magnetic film, a magnetic domain controlling film to magnetize the soft magnetic film in one direction separated by a given distance on the soft magnetic film, and a thinner protection film covering the part of the soft magnetic film between the separated magnetic domain controlling film than the magnetic domain controlling film.

2. A magnetoresistive sensor as defined in claim 1, further comprising a ferromagnetic film and a non-magnetic film provided between the soft magnetic film and the ferromagnetic film.

3. A magnetoresistive sensor as defined in claim 2, still further comprising an antiferromagnetic film having its pinned magnetization through the bonding to the ferromagnetic film with exchange interaction.

4. A magnetoresistive sensor as defined in claim 3, wherein the ferromagnetic film, the non-magnetic film, the soft magnetic film and the antiferromagnetic film constitute a spin valve film structure.

5. A magnetoresistive sensor as defined in claim 2, wherein the ferromagnetic film, the non-magnetic film and the soft magnetic film constitute a ferromagnetic tunnel junction.

6. A magnetoresistive sensor as defined in claim 1, wherein the magnetic domain controlling film is composed of an anti-ferromagnetic film.

7. A magnetoresistive sensor as defined in claim 6, wherein the antiferromagnetic film to constitute the magnetic domain controlling film is composed of at least one selected from the group consisting of a IrMn film, a FeMn film, a NiMn film, a NiO film, a PtMn film, a PtCr film, a PtPdMn film, a RuMn film, a RuRhMn film and a RhMn film.

8. A magnetoresistive sensor as defined in claim 1, wherein the magnetic domain controlling film is composed of a hard magnetic film.

9. A method for manufacturing a magnetoresistive sensor as defined in claim 1 comprising the steps of:
forming the protection film on the soft magnetic film,
forming the magnetic domain controlling film on the protection film, and
removing the central part of the magnetic domain controlling film.
